(19) United States
(12) Patent Application Publication
(10) Pub. No.: US 2019/0392407 A1
(43) Pub. Date: Dec. 26, 2019

(54) ENCRYPTED ASSET TRANSFER SYSTEM AND METHOD FOR FACILITATING TRANSFER OF DIGITAL ASSETS

(71) Applicant: Innoplexus AG, Eschborn (DE)

(72) Inventor: Abhijit Keskar, Pune (IN)

(21) Appl. No.: 16/147,600

(22) Filed: Sep. 29, 2018

Related U.S. Application Data
(60) Provisional application No. 62/688,773, filed on Jun. 22, 2018.

(51) Int. Cl. G06Q 20/06; G06Q 50/18; H04L 9/06; G06Q 20/36

(52) U.S. Cl. CPC G06Q 20/065; G06Q 20/363; H04L 9/0637; G06Q 50/186

(57) ABSTRACT

Disclosed is an encrypted asset transfer system, that facilitates a transfer of digital assets, the system comprising a server arrangement that receives information pertaining to the digital assets, a transferal condition; encrypts the digital assets using a first key and a second key, wherein the server arrangement stores the first key and the second key is transmitted to the second client device of the second party; obtains an access identifier for accessing the encrypted one or more digital assets stored in a distributed file system; add a smart contract to a blockchain; activates a ledger clock for the smart contract; enables the second party to retrieve the digital asset, in response to an execution of the smart contract at a completion of a ledger clock cycle.

### CROSS-REFERENCE TO RELATED APPLICATIONS

This is a non-provisional patent application based upon a U.S. provisional patent application no. 62/688,773 as filed on Jun. 22, 2018, and claims priority under 35 U.S.C. 199(e), the disclosure of which is incorporated herein by reference in its entirety.

### TECHNICAL FIELD

The present disclosure relates generally to encrypted transfer of digital assets; and more specifically, to encrypted asset transfer systems, that when operated, facilitate transfer of digital assets from first party to second party. Furthermore, the present disclosure also relates to methods of facilitating transfer of digital assets from first party to second party.

### BACKGROUND

With advent in digital currency technology, business and commercial transactions involving digital currencies have increased manifold. Typically, the digital currencies are currencies in digital form having a virtual or real monetary value associated therewith. Furthermore, in recent years, the use of virtual currencies such as crypto-currencies has revolutionized the field of business and commercial transactions. Notably, such crypto-currencies and data such as an image, a video, a text file, a data base, and so forth form digital assets of an individual.

However, increase in number of people acquiring digital assets, and intangible nature of such digital assets has led to major concerns associated with inheritance of said digital assets. In most cases, the one or more rightful heirs of the owner are not aware about the digital assets. Consequently, the digital assets remain unattended for a long time and may even be abandoned. Furthermore, a lack of defined set of rules for inheritance of such digital assets may lead to confusion amongst the one or more rightful heirs. Moreover, the inheritance of said digital assets is not transferred to the one or more rightful heirs at a time, mandated by the owner. Subsequently, the one or more rightful heirs or the owner may face difficulty due to delayed and troublesome process for transferring the digital assets.

Conventionally, the owner of the digital assets communicates the information pertaining to the digital assets such as security numbers associated with the digital assets to the one or more rightful heirs directly. However, providing the security numbers associated with the digital assets allows the one or more rightful heirs to access the digital assets before a desired time. In an example, an owner of digital assets may provide the security numbers associated with the digital assets to an heir in faith. However, in such case, there is a risk of fraudulent and misuse of the provided information by the heir. Moreover, disclosing the security numbers through conventional methods may have associated risks such as false transfer of ownership, misuse, fraudulent, and so forth. Furthermore, in an exemplary condition, due to sudden demise of the owner, there may be no means to safely communicate the information pertaining to the digital assets such as the security numbers associated with the digital assets to the one or more rightful heirs.

Therefore, there is a need to overcome the aforementioned drawbacks associated with conventional methods of transferring digital assets.

### SUMMARY

The present disclosure seeks to provide an encrypted asset transfer system, that when operated, facilitates a transfer of digital assets from a first party to a second party. The present disclosure also seeks to provide a method of facilitating a transfer of digital assets from a first party to a second party. The present disclosure seeks to provide a solution to the existing problem of lack of reliable and secure means for establishing guidelines for transferring the digital assets from the first party to the second party. An aim of the present disclosure is to provide a solution that overcomes at least partially the problems encountered in prior art, and provides a reliable and secure process that facilitates the transfer of the digital assets from the first party to the second party.

In one aspect, an embodiment of the present disclosure provides an encrypted asset transfer system, when in operation, facilitates a transfer of one or more digital assets from a first party to a second party, the encrypted asset transfer system comprising a server arrangement communicably coupled via one or more communication networks with a first client device of the first party and with a second client device of the second party, wherein the server arrangement:
receives, from the first client device of the first party, information pertaining to the one or more digital assets, a transferal condition, identification details of the second party;
encrypts the one or more digital assets using a first key and a second key, wherein the server arrangement stores the first key and the second key is transmitted to the second client device of the second party;
obtains an access identifier for accessing the encrypted one or more digital assets, wherein the encrypted one or more digital assets are stored in a distributed file system;
adds a smart contract to a blockchain, wherein the smart contract comprises the transferal condition, a validation indicator, and the access identifier, and wherein activation of the validation indicator in the smart contract indicates a satisfaction of the transferal condition;
activates a ledger clock for the smart contract, wherein the ledger clock is configured to defer an execution of the smart contract to a next cycle of the ledger clock in response to absence of activation of the validation indicator in the smart contract;
enables the second party to retrieve the one or more digital assets, in response to an execution of the smart contract at a completion of a ledger clock cycle, using the second key and the access identifier of the encrypted one or more digital assets, wherein the execution of the smart contract is based on activation of the validation indicator.

In another aspect, an embodiment of the present disclosure provides a method for facilitating a transfer of one or more digital assets from a first party to a second party, wherein the method is implemented via an encrypted asset transfer system comprising a server arrangement communicably coupled via one or more communication networks with a first client device of the first party and with a second client device of the second party, the method comprising:
receiving, from the first client device of the first party, information pertaining to the one or more digital assets, a transferal condition, identification details of the second party;
encrypting the one or more digital assets using a first key and a second key, wherein the server arrangement stores the first key and the second key is transmitted to the second client device of the second party;
obtaining an access identifier for accessing the encrypted one or more digital assets, wherein the encrypted one or more digital assets is stored in a distributed file system;
adding a smart contract to a blockchain, wherein the smart contract comprises the transferal condition, a validation indicator and the access identifier, and wherein activation of the validation indicator in the smart contract indicates a satisfaction of the transferal condition;
activating a ledger clock for the smart contract, the ledger clock configured to defer an execution of the smart contract to a next cycle of the ledger clock in response to absence of activation of the validation indicator in the smart contract;
enabling the second party to retrieve the digital asset, in response to an execution of the smart contract at a completion of a ledger clock cycle, using the second key and the access identifier of the encrypted one or more digital assets, wherein the execution of the smart contract is based on activation of the validation indicator.

Embodiments of the present disclosure substantially eliminate or at least partially address the aforementioned problems in the prior art, and enable reliable and secure means for transferring the digital assets from the first party to the second party with minimal human intervention as per the guidelines defined by the first party.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a network environment, wherein an encrypted asset transfer system for facilitating a transfer of one or more digital assets from a first party to a second party is implemented, pursuant to an embodiment of the present disclosure;

FIG. 2 is a schematic illustration of a high-level architecture of a network environment in which an encrypted asset transfer system for facilitating a transfer of one or more digital assets from a first party to a second party is implemented, pursuant to a specific embodiment of the present disclosure;

FIG. 3 is a flow chart depicting steps of a method of facilitating a transfer of one or more digital assets from a first party to a second party, in accordance with an embodiment of the present disclosure;

FIGS. 4A, 4B, 4C and 4D are example views of a user interface of an encrypted asset transfer system presented on a graphical user interface of a first client device or a first server of a first party, in accordance with an embodiment of the present disclosure; and

FIG. 5 is an example view of a user interface of an encrypted asset transfer system to provide credentials related to a transferal condition, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides an encrypted asset transfer system, when in operation, facilitates a transfer of one or more digital assets from a first party to a second party, the encrypted asset transfer system comprising a server arrangement communicably coupled via one or more communication networks with a first client device of the first party and with a second client device of the second party, wherein the server arrangement:
receives, from the first client device of the first party, information pertaining to the one or more digital assets, a transferal condition, identification details of the second party;
encrypts the one or more digital assets using a first key and a second key, wherein the server arrangement stores the first key and the second key is transmitted to the second client device of the second party;
obtains an access identifier for accessing the encrypted one or more digital assets, wherein the encrypted one or more digital assets are stored in a distributed file system;
adds a smart contract to a blockchain, wherein the smart contract comprises the transferal condition, a validation indicator, and the access identifier, and wherein activation of the validation indicator in the smart contract indicates a satisfaction of the transferal condition;
activates a ledger clock for the smart contract, wherein the ledger clock is configured to defer an execution of the smart contract to a next cycle of the ledger clock in response to absence of activation of the validation indicator in the smart contract;
enables the second party to retrieve the one or more digital assets, in response to an execution of the smart contract at a completion of a ledger clock cycle, using the second key and the access identifier of the encrypted one or more digital assets, wherein the execution of the smart contract is based on activation of the validation indicator.

In another aspect, an embodiment of the present disclosure provides a method for facilitating a transfer of one or more digital assets from a first party to a second party, wherein the method is implemented via an encrypted asset transfer system comprising a server arrangement communicably coupled via one or more communication networks with a first client device of the first party and with a second client device of the second party, the method comprising:
receiving, from the first client device of the first party, information pertaining to the one or more digital assets, a transferal condition, identification details of the second party;
encrypting the one or more digital assets using a first key and a second key, wherein the server arrangement stores the first key and the second key is transmitted to the second client device of the second party;
obtaining an access identifier for accessing the encrypted one or more digital assets, wherein the encrypted one or more digital assets is stored in a distributed file system;
adding a smart contract to a blockchain, wherein the smart contract comprises the transferal condition, a validation indicator and the access identifier, and wherein activation of the validation indicator in the smart contract indicates a satisfaction of the transferal condition;
activating a ledger clock for the smart contract, the ledger clock configured to defer an execution of the smart contract to a next cycle of the ledger clock in response to absence of activation of the validation indicator in the smart contract;
enabling the second party to retrieve the digital asset, in response to an execution of the smart contract at a completion of a ledger clock cycle, using the second key and the access identifier of the encrypted one or more digital assets, wherein the execution of the smart contract is based on activation of the validation indicator.

The present disclosure provides the aforementioned system, and the aforementioned method for facilitating the transfer of the one or more digital assets. Beneficially, the system and the method described herein allows the first party to transfer the one or more digital assets to the rightful heir of the one or more digital assets, via the encrypted asset transfer system. Moreover, the transfer of the one or more digital assets is performed in a reliable and secure manner.

Furthermore, the encrypted asset transfer system executes a transaction for transferring the one or more digital assets in an encrypted form and with minimal human involvement thereby preventing the associated security threats such as theft or invalid transactions. The aforesaid system and the aforesaid method transfers the one or more digital assets of the first party to the second party upon fulfilment of a condition in real life such as, for example, death of the first party (namely, owner of the one or more digital assets), the second party (namely, an intended heir of the one or more digital assets) reaching an age limit and so forth. As a result, the encrypted asset transfer system automatically transfers the one or more digital assets after the validation of the smart contract thereby preventing abandonment of the said one or more digital assets.

Additionally, the second party cannot access the one or more digital assets until the transferal condition provided by the first party is met. Consequently, the one or more digital assets are transferred to the second party at a predetermined time defined by the first party. Moreover, the aforementioned system and the aforementioned method generates a smart contract that enables transparent and methodical transfer of the one or more digital assets from the first party to the second party.

It will be appreciated that the encrypted asset transfer system proffers a platform to achieve a technical effect of enabling methodical and transparent transfer of the one or more digital assets from the first party to the second party. Moreover, the aforesaid system prevents loss or abandonment of one or more digital assets thereby preventing any financial risk or uncertainty associated with the one or more digital assets. Consequently, a technical effect can be achieved on real life contingencies by addressing financial losses. Additionally, the system and method described herein enhances the operational characteristics of a computer. It will be appreciated that the system addresses a crucial drawback associated with the one or more digital assets and the use thereof by providing the aforesaid platform for overcoming the security threats associated with the transfer of the one or more digital assets. Furthermore, the use of the blockchain to implement the encrypted asset transfer system provides greater transparency, enhanced security, improved traceability, increased efficiency and speed of transactions.

The encrypted asset transfer system facilitates the transfer of the one or more digital assets from the first party to the second party. The encrypted asset transfer system enables the first party to create a user account and store information pertaining to the one or more digital assets, which can later be accessed to facilitate the transfer of said one or more digital assets from the first party to the second party.

It will be appreciated that the aforesaid system and the aforesaid method are not limited to facilitating the transfer of the one or more digital assets from the first party to only a singular second party. The system and method enable the first party to designate a plurality of second parties. Subsequently, the system and method can be employed to facilitate the transfer of the one or more digital assets from the first party to the designated plurality of second parties. Typically, the first party define a share associated with the one or more digital assets for the transfer thereof, amongst each of the plurality of second parties. In an example, the one or more digital assets may be divided equally for facilitating the transfer of the one or more digital assets amongst each of the plurality of second parties. In another example, the one or more digital assets may be divided in a proportion defined by the first party for facilitating the transfer of the one or more digital assets amongst each of the plurality of second parties.

It will be appreciated that the terms “first”, “second” and the like herein do not denote any specific role or order or importance, but rather are used to distinguish one party from another. In other words, the first party and the second party can act as a transmitting party and a receiving party, respectively, at a given point of time, and can act as a receiving party and a transmitting party, respectively, at another point of time.

Throughout the present disclosure, the term “one or more digital assets” refers to an intangible personal property such as a digitally stored content or an online account owned by an individual (namely, the first party). Examples of the one or more digital assets can include but are not limited to digital data (such as, image files, audio files, video files, and so forth), digital documents (such as, text files, legal documents, documents pertaining to a field of art, and so forth), digital currencies (such as, electronic money, virtual currencies, cryptocurrencies, and so forth), online accounts having value to an estate, and web-accessible addresses. Moreover, the one or more digital assets can be a folder comprising a combination of the aforementioned types of one or more digital assets. In a first example, a folder of the one or more digital assets of the first party may comprise a combination of the one or more digital assets such as digital currencies, an online social media account, a link pertaining to a web-accessible address, and a digital data. In a second example, a folder of the one or more digital assets of the first party may comprise a plurality of image files, wherein the plurality of image files may have specified attributes and can perform tailored actions. In a third example, the one or more digital assets of the first party may be a folder containing files, wherein the files consist of specialized or confidential instructions to perform a specified task (for example, a computer software or a computer application). Furthermore, the one or more digital assets can also include a group of folders, wherein a plurality of the folders comprising a combination of the aforementioned types of one or more digital assets are linked to each other.

Throughout the present disclosure, the terms “first party” and “second party” refer to a first user and a second user respectively, who acts as clients to the server arrangement in a client/server relationship. The first party and the second party can be any entity including a person (i.e., human being) or a virtual personal assistant (an autonomous program or a bot) using the system and method described herein.

It will be appreciated that the one or more digital assets may have been provided by an owner. The first party can be the owner of the one or more digital assets or a representative of the owner of the one or more digital assets, who uses the aforesaid encrypted asset transfer system to facilitate the transfer of the one or more digital assets to the second party. Notably, the first party is intended to provide the one or more digital assets or an information pertaining to the one or more digital assets, to the server arrangement for processing thereof. Additionally, the first party is intended to designate the second party. Moreover, the second party can be, for example, an individual, who is a rightful heir of the one or more digital assets provided by the first party for transfer thereof, or a representative of an individual, who is a rightful heir of the one or more digital assets. The system and method described herein facilitates the transfer of said one or more digital assets from the first party to the second party.

The encrypted asset transfer system comprises a server arrangement. Throughout the present disclosure, the term “server arrangement” refers to an arrangement of one or more servers that includes one or more processors configured to perform various operations, for example, as mentioned earlier. Optionally, the server arrangement includes any arrangement of physical or virtual computational entities capable of performing the various operations. The term “one or more processors” may refer to one or more individual processors, processing devices and various elements associated with a processing device that may be shared by other processing devices. Additionally, the one or more individual processors, processing devices and elements are arranged in various architectures for responding to and processing the instructions that drive the aforesaid system.

Moreover, it will be appreciated that the server arrangement can be implemented by way of a single hardware server. The server arrangement can alternatively be implemented by way of a plurality of hardware servers operating in a parallel or distributed architecture. As an example, the server arrangement may include components such as a memory unit, a processor, a network adapter, and the like, to store and process information pertaining to the document and to communicate the processed information to other computing components, for example, such as a client device. Furthermore, the server arrangement comprises a database arrangement for storing data therein.

Throughout the present disclosure, the term “server” generally refers to a device executing an application, program, or process in a client/server relationship that responds to requests for information or services by another application, program, process, or device (namely, a client) on a data communication network. Optionally, a given server is implemented by way of a device executing a computer program that provides various services (for example, such as a database service) to other devices, modules, or apparatus.

The term “client device” generally refers to a device executing an application, program, or process in a client/server relationship that requests information or services from another application, program, process, or device (namely, a server) on a data communication network. Importantly, the terms “client” and “server” are relative, as an application may be a client to one application but a server to another application. Moreover, the client device can be electronic device associated with (or used by) a user (namely, a first party and a second party), that is capable of enabling the user to perform specific tasks associated with the aforementioned system/method. Furthermore, the client device is intended to be broadly interpreted to include any electronic device that may be used for voice and/or data communication over a wireless communication network.

Examples of the first and second client devices include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, large-sized touch screens with embedded PCs, a server, and Network-Attached Storage (NAS) devices.

Notably, the first and second client devices are configured to function as a “client” in a client/server relationship with the server arrangement. However, the first and second client devices may be configured to function as a “server” in a client/server relationship with other computing devices. Throughout the present disclosure, the terms “first client device” and “second client device” refer to devices associated with a first user and a second user that acts as clients to the server arrangement in a client/server relationship, wherein such devices can be personal devices or servers in local environments of the first user and the second user, respectively. As an example, the first client device can be an internal server of an owner of one or more digital assets (namely, the first party), while the second client device can be an internal server of an individual to whom the said one or more digital assets is to be transferred (namely, the second party).

The server arrangement is communicably coupled via one or more communication networks with the first client device of the first party and with the second client device of the second party. The term “one or more communication networks” can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, fifth generation (5G) telecommunication networks and Worldwide Interoperability for Microwave Access (WiMAX) networks.

The server arrangement receives, from the first client device of the first party, the information pertaining to the one or more digital assets, the transferal condition, the identification details of the second party. In other words, the server arrangement receives aforementioned attributes (namely, the information pertaining to the one or more digital assets, the transferal condition, the identification details of the second party) pertaining to the transfer of the one or more digital assets, from the first party via the first client device (or a first server). The server arrangement presents to the first party a user interface, via the first client device of the first party, that allows the first party to input the aforementioned attributes. In an embodiment, the server arrangement may present a questionnaire on the user interface of the first client device (or the first server) of the first party.

Optionally, the information pertaining to the one or more digital assets comprises at least one of: a type of the one or more digital assets, a valuation associated with the one or more digital assets. Notably, the one or more digital assets may be in type of, but not limited to, digital data, digital documents, digital currencies, online accounts, web-accessible address, and so forth, as mentioned earlier. Moreover, the valuation associated with the one or more digital assets is a monetary value or a monetary worth of the one or more digital assets.

Moreover, optionally, the term “transferal condition” refers to circumstances or factors, that affect the procedure of transfer of the one or more digital assets from the first party to the second party. In other words, the transferal condition is a criterion defined by the first party, that when fulfilled, enables the server arrangement to execute the transfer of the one or more digital assets from the first party to the second party. It will be appreciated that the first party may provide a plurality of transferal conditions. In an example, the transferal condition defined by the first party may be demise of the first party. In another example, the transferal condition defined by the first party may be associated with an age of the second party such as reaching eighteen years of age. In yet another example, the transferal condition defined by the first party may be associated with an educational qualification of the second party such as upon obtaining a graduation degree by the second party.

Optionally, the identification details of the second party comprise at least one of: a name, a country, an e-mail address, a social security number, and a relation of the second party with the first party. Moreover, the e-mail address refers to an electronic mailing address associated with the second party. Additionally, the social security number refers to a unique identification number associated with the second party. Optionally, the social security number may be a unique identification number associated with a bank account of the second party. In an example, the name of the second party may be ‘Alice’, the country of the second party may be ‘Canada’, the e-mail address of the second party may be ‘Alice@xyz.com’, the social security number of the second party may be ‘123456789’, and the relation of the second party with the first party may be ‘spouse’. In another example, the name of the second party may be ‘Bob’, the country of the second party may be ‘China’, the e-mail address of the second party may be ‘Bob@abc.com’, the social security number of the second party may be ‘987654321’, and the relation of the second party with the first party may be ‘son’. Beneficially, the identification details of the second party, provided by the first party can be employed to validate identity of the second party thereby preventing any confusion and risks pertaining to identity theft.

In an embodiment, the server arrangement may store the identification details of the second party. Pursuant to embodiments of the present disclosure, the server arrangement of the aforesaid system may store the identification details of the second party locally or in a database arrangement associated with the server arrangement. Optionally, the database arrangement comprises one or more databases. The database arrangement includes any data storage software and systems, such as, for example, a relational database like IBM DB2, Oracle 9, and so forth.

Optionally, in an instance, there can be a plurality of second parties. Subsequently, in such case, the server arrangement receives a distribution terms from the first party. Notably, the term “distribution terms” refers to conditions or clauses defined by the first party to quantify a distribution of one or more digital assets amongst the plurality of second parties. In an embodiment, the one or more digital assets owned by the first party may include digital currencies stored in a digital wallet. In an example, the first party may divide the digital currencies equally (such that each of the plurality of second parties get an equal share of the digital currencies) amongst the plurality of second parties. In another example, the first party may assign a certain percentage of the digital currencies for each of the plurality of second parties. In another embodiment, the one or more digital assets owned by the first party may be a folder that includes a text file, an audio file, a digital account, and digital currencies. In such case, the first party may assign a type of the one or more digital assets to each of the second party from amongst the plurality of second parties.

The server arrangement further encrypts the one or more digital assets using the first key and the second key. In other words, the server arrangement double-encrypts the one or more digital assets by employing the first key and the second key.

In an embodiment, the first party may be presented with the remote module that facilitates the encryption of said one or more digital assets from the first party to the second party using a graphical user interface, via the first client device. The server arrangement triggers the remote module for encryption of the one or more digital assets. Furthermore, the remote module is implemented by way of an intermediary platform. Optionally, the intermediary platform is implemented by way of a trusted software application that, when executed at the first client device, obtains the one or more digital assets. Optionally, in such a case, the trusted software application is received (for example, downloaded) from the server arrangement or a trusted third party. The trusted third party can be a publicly-accessible digital distribution platform, for example, such as Google Play®, the App Store® (for iOS®) and the like.

In an embodiment, the first party may provide the one or more digital assets to the remote module directly. In a first example, the first party may upload the one or more digital assets such as image files, text files, and so forth directly to the remote module by employing the first client device. In another embodiment, the first party may provide an information such as a link, a username, a security pin, a security password, and so forth associated with one or more digital assets for access thereof. In a second example, the first party may provide a link associated with a web-accessible address for accessing the digital asset of the first party. In a third example, the first party may provide a security pin for accessing a digital wallet containing digital currencies.

In an embodiment, the first key is generated by the server arrangement and the second key is generated by the remote module. The first key and the second key used to double-encrypt the one or more digital assets may, for example, be a hash function, a mathematical operator, a mathematical operation and so forth. More optionally, the first key and the second key may be stored by the server arrangement locally or in the database arrangement. It will be appreciated that the keys (namely, the first key and the second key) used for the encryption of the one or more digital assets may also be employed for decryption of the one or more digital assets.

Furthermore, the server arrangement stores the first key. Specifically, the first key may be stored by the server arrangement locally or in the database arrangement. Furthermore, the database arrangement may be a relational database. Beneficially, the server arrangement stores only the first key locally or in the database arrangement, thereby preventing any security threats associated with the encryption keys.

Furthermore, the server arrangement sends the second key to the second client device of the second party. Specifically, the second key is provided to the second party for de-encrypting the double-encrypted information pertaining to the one or more digital assets. In an example, the server arrangement may provide the second key to the second party via an e-mail. In another example, the second key may be rendered upon the graphical user interface of the second client device (or the second server) of the second party.

It will be appreciated that the one or more digital assets and the second key are not communicated to the server arrangement. Therefore, the server arrangement does not have any direct access to the one or more digital assets and also, cannot decrypt the encrypted one or more digital assets due to a lack of the second key. Beneficially, the security of the one or more digital assets is uncompromised.

The server arrangement obtains an access identifier for accessing the encrypted one or more digital assets, wherein the encrypted one or more digital assets are stored in a distributed file system. The distributed file system provides a protocol for storing and exchanging documents for peer-to-peer transfers. Furthermore, the encrypted one or more digital assets are stored at various peer nodes pertaining to the distributed file system. The peer nodes are not dependent on each other; this ensures that the distributed file system has no failures due to non-functionality of any of the peer records. This makes the distributed file system secure. An example of the distributed file system is InterPlanetary File System (IPFS). Furthermore, the server arrangement stores the access identifier for accessing the encrypted one or more digital assets in a database arrangement associated therewith.

Furthermore, the distributed file system provides the access identifier, wherein the access identifier is associated with a location of storage of the one or more digital assets in the distributed file system. In other words, the access identifier refers to a location associated with the peer nodes, where the encrypted one or more digital assets are stored. In an embodiment, the access identifier may be a hyperlink that can be used to obtain the encrypted one or more digital assets.

In an embodiment, the encrypted one or more digital assets are communicated to the server arrangement after the encryption of the one or more digital assets. Subsequently, the server arrangement stores the encrypted one or more digital assets in the distributed file system and obtains the access identifier.

In another embodiment, the server arrangement may trigger the remote module to store the encrypted one or more digital assets in the distributed file system and obtain the access identifier. Thereafter, the remote module may communicate the access identifier to the server arrangement.

In yet another embodiment, the first party may, after encryption of the one or more digital assets, store the encrypted one or more digital assets in the distributed file system independently and obtain the access identifier. Thereafter, the first party may communicate the access identifier to the server arrangement. Consequently, the server arrangement obtains the access identifier for accessing the encrypted one or more digital assets stored in the distributed file system.

The server arrangement adds a smart contract to a blockchain, wherein the smart contract comprises the transferal condition, a validation indicator, and the access identifier. Throughout the present disclosure, the term “smart contract” refers to a document comprising a plurality of terms and conditions pertaining to a consensus, wherein the consensus is established between the first party and the second party regarding the transfer of the one or more digital assets. Moreover, the smart contract permits trusted execution of the consensus between the first party and the second party, without involving a central authority, legal system, or externally enforced mechanisms. The smart contract defines the plurality of terms and conditions pertaining to the consensus based upon the transferable condition, that enables the execution of the consensus in a traceable, transparent, and irreversible manner.

Notably, the blockchain stores a plurality of blocks. More specifically, in the blockchain, each block stores a cryptographic hash of a previous block, new information stored in the block and a timestamp associated with the block. The plurality of terms and conditions pertaining to the consensus of the smart contract may be written in form of codes or algorithms. Pursuant to embodiments of the present disclosure, the smart contract is added to a block in the blockchain as new information stored in the block. Furthermore, the blockchain is managed by a peer-to-peer network collectively adhering to a protocol for inter-block communication and validating new blocks in a blockchain. Moreover, once a block is stored in the blockchain the block cannot be altered. Thus, storing the smart contract in the blockchain provides an immutable block comprising the consensus pertaining to the smart contract with its associated timestamp.

Optionally, the smart contract comprises at least one of: a distinctive identification associated with the first party, a distinctive identification associated with the second party, and a proof of witness. It will be appreciated that the first party defines the said transferal condition.

Furthermore, the smart contract is generated by the server arrangement by employing the blockchain. The transferal condition received by the server arrangement is embodied as terms and conditions of the smart contract. Furthermore, the blockchain prevents any one party from controlling or altering the smart contract. Subsequently, the smart contract is executed only when the transferal condition defined by the first party, in the smart contract is satisfied.

The smart contract comprises the validation indicator, wherein the validation indicator is activated upon satisfaction of the transferal condition. Typically, the validation indicator is implemented by way of a set of codes and/or a set of algorithms. In an embodiment, the validation indicator is implemented by way of a flag function.

Optionally, the server arrangement receives credentials relating to the transferal condition. The term “credentials relating to the transferal condition” refers to a document or a data that verifies the satisfaction of the transferal condition. In other words, the credentials relating to the transferal condition refers to a document or a data that provides a proof of satisfaction of the transferal condition. In an example, the transferal condition may be death of the first party. In such example, the credentials relating to the transferal condition may be a death certificate of the first party. In another example, the transferal condition may be acquiring an educational qualification by the second party. In such example, the credentials relating to the transferal condition may be a graduation degree of the second party obtained from an institution.

Optionally, the server arrangement may receive credentials relating to the transferal condition via at least one of a plurality of sources. Moreover, for example, the plurality of sources providing the credentials relating to the transferal condition may be the first party, second party, a government body, an event occurrence submit console or a third party, wherein the third party is an unknown user.

Furthermore, optionally, the server arrangement authenticates the credentials related to the transferal condition. Specifically, the server arrangement may validate the authenticity of the credentials related to the transferal condition provided by the plurality of sources. More specifically, the server arrangement may communicate with a central regulatory or a central authority, to authenticate the credentials related to the transferal condition. In an example, the credentials related to the transferal condition may be a death certificate of the first party. In such example, the server arrangement may communicate with a government registrar to validate the authenticity of the death certificate of the first party. In another example, the credentials related to the transferal condition may be a graduation degree of the second party that is issued by an institution. In such example, the server arrangement may communicate with the institution to validate the authenticity of the graduation degree of the second party.

Optionally, the server arrangement adds, in the blockchain, a validation block based on the credentials relating to the transferal condition. Typically, the server arrangement stores the authenticated credentials related to the transferal condition in form of a block (namely, validation block) in the blockchain. In other words, a validation block is added upon the authentication of the credentials relating to the transferal condition, in the blockchain. Optionally, the validation block added to the blockchain may be in communication with the block comprising the smart contract. It is to be understood that the validation block refers to a block comprising the credentials relating to the transferal condition. In an embodiment, the block comprising the credentials relating to the transferal condition (namely, the validation block) may also comprise information unrelated to the transferal condition

Optionally, the validation block comprises information associated with the credentials relating to the transferal condition. Specifically, the server arrangement identifies important and specific data associated with the credentials relating to the transferal condition. More specifically, the server arrangement extracts the important and specific data from the credentials relating to the transferal condition and stores thereto in the validation block. In an example, the credentials relating to the transferal condition may be a death certificate of the first party. In such example, the server arrangement may extract at least one of: a serial number associated with the death certificate, an organizational body issuing the death certificate, and information pertaining to the death of the first party such as a date, a time, a reason and so forth.

Pursuant to embodiments of the present disclosure, a connection may be established between the validation block that is operable to store the authenticated credentials related to the transferal condition and the block that stores the smart contract. Moreover, once a block is stored in the blockchain, the block cannot be altered. Thus, storing the authenticated credentials related to the transferal condition in form of the validation block on the blockchain provides an immutable proof of the satisfaction of the transferal condition.

The server arrangement activates a ledger clock for the smart contract. It will be appreciated that the addition of the smart contract to the blockchain triggers a ledger clock. The term “ledger dock” refers to an entity associated with a block in the blockchain that defines a timestamp for the execution thereof. Specifically, the ledger clock can be referred to a clock associated with a block on the block, wherein the clock administers the time of execution of the block in the blockchain. The ledger clock of the block is triggered once the block is added to the blockchain. Furthermore, the ledger clock has ledger clock cycles associated therewith, wherein the ledger clock administers an attempt at the execution of the smart contract at the completion of each ledger clock cycle. Specifically, at the completion of every ledger clock cycle, the activation of the validation indicator is checked. In an instance, when the validation indicator has been not activated, the ledger clock is configured to defer the execution of the smart contract to a next cycle of the ledger clock. In other words, the ledger clock is configured to defer the execution of the smart contract to the next cycle of the ledger clock in response to absence of activation of the validation indicator in the smart contract. In another instance, when the validation indicator has been activated, the ledger clock is configured to execute the smart contract at the completion of a ledger clock cycle. As discussed previously, the validation indicator is activated upon satisfaction of the validation condition.

The server arrangement enables the second party to retrieve the one or more digital assets, in response to the execution of the smart contract at a completion of a ledger clock cycle. Furthermore, the second party is enables to retrieve, using the second client device, the one or more digital assets using the second key and the access identifier of the encrypted one or more digital assets. As mentioned previously, the server arrangement stores the access identifier and the first key therewith. Consequently, in response to the execution of the smart contract, the encrypted one or more digital assets are retrieved from the distributed file system using the access identifier. Subsequently, the encrypted one or more digital assets are decrypted using the first key (stored in the server arrangement) and the second key (obtained from the second party).

In one embodiment, the server arrangement provides the first key, and the access identifier for accessing the encrypted one or more digital assets, upon execution of the smart contract, to the second client device of the second party. As mentioned previously, the second key is transmitted to the second party after the encryption of the one or more digital assets. Therefore, the second party employs the access identifier for retrieving the encrypted one or more digital assets from the distributed file system. Subsequently, the second party, using the second client device, decrypts the encrypted one or more digital assets using the first key and the second key. Optionally, the first key and the access identifier for accessing the encrypted one or more digital assets may be provided to the second party via an electronic mail.

In another embodiment, the server arrangement may acquire the first key and the access identifier for accessing the encrypted information pertaining to the one or more digital assets from the distributed file system. In such embodiment, the server arrangement, using the second client device, requests the second party to provide the second key (transmitted to the second party previously) to the server arrangement. Thereafter, the server arrangement retrieves the encrypted one or more digital assets from the distributed file system using the access identifier. Subsequently, the server arrangement decrypts the encrypted one or more digital assets using the first key (stored with the server arrangement) and the second key (provided to the server arrangement by the second party). Consequently, the server arrangement provides the one or more digital assets to the second party on the second client device.

Optionally, the server arrangement further provides an intimation message to the second party upon not receiving the credentials relating to the transferal condition prior to completion of a given ledger clock cycle. Specifically, the smart contract is executed only upon receiving credentials relating to the transferal condition. However, upon not receiving the credentials relating to the transferal condition, the intimation message is sent to the second party. Optionally, the intimation message may be provided to the second party via an electronic mail. More optionally, the intimation message may be presented on the graphical user interface of the second client device (or second server) of the second party.

Optionally, in an embodiment, the server arrangement enables the first party, via the graphical user interface of the first client device (or the first server), communicably coupled to the server arrangement, to modify the transferal condition, the information pertaining to the one or more digital assets, and/or the identification details of the second party. In such case, the server arrangement terminates the smart contract associated with the foregoing information. Furthermore, the server arrangement adds a new smart contract record pertaining to the modified information provided by the first party via the first client device, to the blockchain.

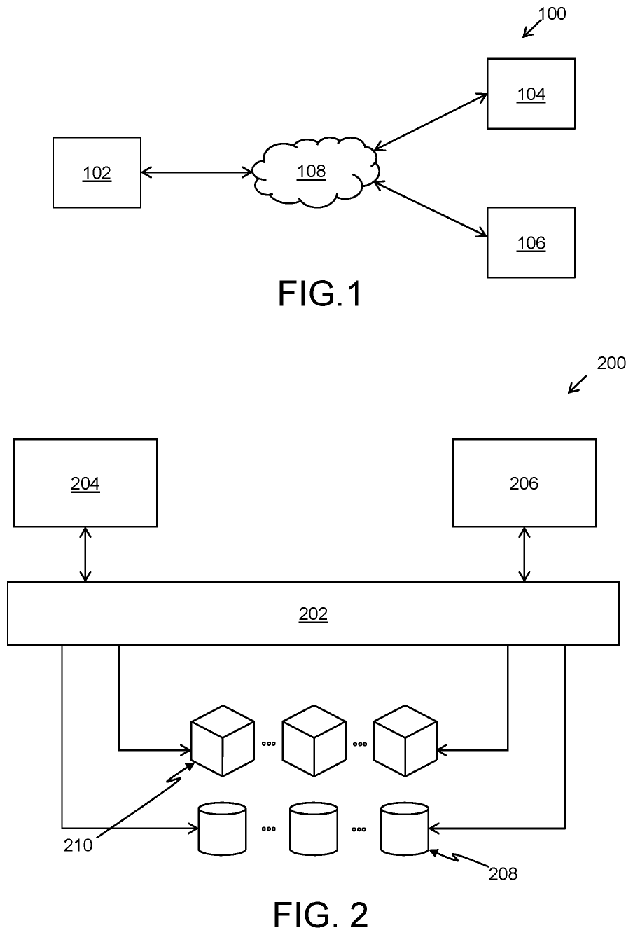

For illustration purposes only, there will now be considered an example network environment, wherein a system for executing an encrypted asset transfer system can be implemented pursuant to embodiments of the present disclosure. One such network environment has been illustrated in conjunction with FIG. 1 as explained in more detail below.

The network environment includes a first client device and a second client device, a server arrangement of the system, a database arrangement of the system, and one or more data communication networks. The server arrangement, comprising one or more processors, is communicably coupled via the one or more data communication networks with the first client device and the second client device. Optionally, the network environment also includes a plurality of database servers communicably coupled via the one or more data communication networks with the one or more processors of the server arrangement.

It will be appreciated that it is not necessary for the one or more processors of the server arrangement to be coupled in communication with all the client devices simultaneously at all times. The one or more processors of the server arrangement are configured to execute machine readable instructions that cause the server arrangement to perform operations, for example, as illustrated with respect to the aforementioned aspect.

Moreover, the present description also relates to the method as described above. The various embodiments and variants disclosed above apply mutatis mutandis to the method.

Optionally, the transferal condition is satisfied upon receiving credential relating to the transferal condition.

Optionally, the method comprises providing the first key and the access identifier for accessing the encrypted information pertaining to the digital assets, upon execution of the smart contract, to the second client device of the second party.

Optionally, the method comprises providing an intimation message to the second party upon not receiving the credentials for satisfaction of the transferal condition prior to completion of a cycle of the ledger clock.

Optionally, the method comprises authenticating the credentials related to the transferal condition.

### DETAILED DESCRIPTION OF THE DRAWINGS

Referring now to the drawings, particularly by their reference numbers, FIG. 1 is a schematic illustration of a network environment 100, wherein an encrypted asset transfer system for facilitating a transfer of one or more digital assets from a first party to a second party is implemented, pursuant to an embodiment of the present disclosure.

The network environment 100 comprises a server arrangement 102, a first client device 104 of the first party and a second client device 106 of the second party. The server arrangement 102 is communicably coupled via one or more communication networks (depicted as a communication network 108) with the first client device 104 of the first party and the second client device 106 of the second party.

FIG. 1 is merely an example, which should not unduly limit the scope of the claims herein. It is to be understood that the specific designation for the network environment 100 is provided as an example and is not to be construed as limiting the network environment 100 to specific numbers, types, or arrangements of server arrangements, client devices, and communication networks. A person skilled in the art will recognize many variations, alternatives, and modifications of embodiments of the present disclosure.

Referring to FIG. 2 illustrated is a schematic illustration of a high-level architecture of a network environment 200 in which an encrypted asset transfer system for facilitating a transfer of one or more digital assets from a first party to a second party is implemented, pursuant to a specific embodiment of the present disclosure.

The network environment 200 comprises a server arrangement 202 including one or more processors, a first client device 204 of the first party and a second client device 206 of the second party. The server arrangement 202 is communicably coupled via one or more communication networks (not shown) with the first client device 204 of the first party and the second client device 206 of the second party.

Moreover, the network environment 200 comprises a distributed file system 208, wherein information pertaining to the one or more digital assets and the first key is stored. Furthermore, the network environment 200 comprises a blockchain 210, wherein the blockchain comprises several blocks such as: smart contract block, validation block, block comprising details pertaining to the transfer of the one or more digital assets from the first party to the second party, and so forth.

FIG. 2 is merely an example, which should not unduly limit the scope of the claims herein. It is to be understood that the specific designation for the network environment 200 is provided as an example and is not to be construed as limiting the network environment 200 to specific numbers, types, or arrangements of server arrangements, client devices, modules, distributed file systems and blockchains. A person skilled in the art will recognize many variations, alternatives, and modifications of embodiments of the present disclosure.

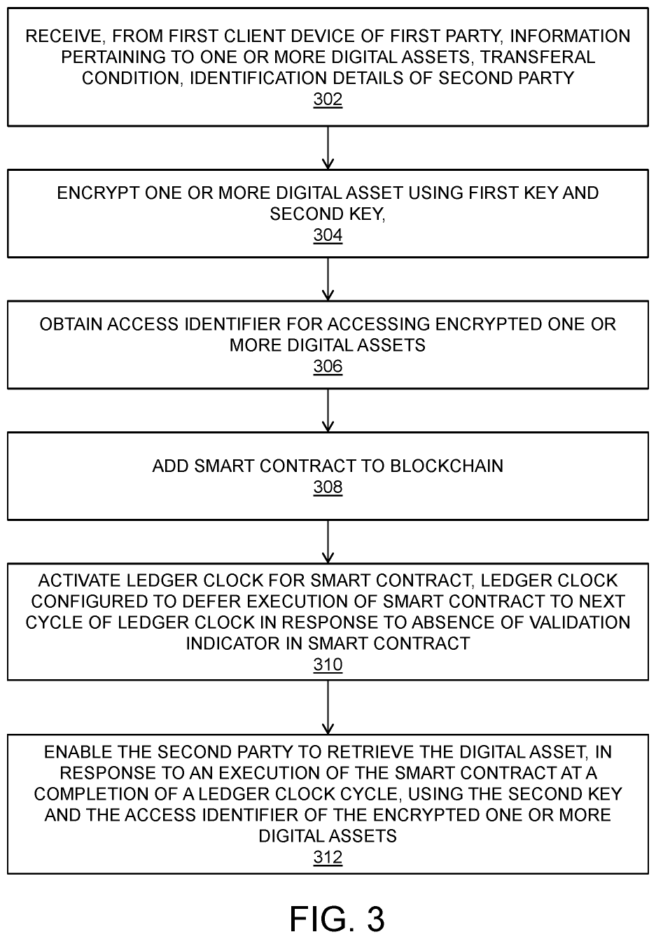

Referring to FIG. 3, illustrated is a flow chart depicting steps of a method of facilitating a transfer of one or more digital assets from a first party to a second party, in accordance with an embodiment of the present disclosure. The method is depicted as a collection of steps in a logical flow diagram, which represents a sequence of steps that can be implemented in hardware, software, or a combination thereof, for example as aforementioned.

The method is implemented via an encrypted asset transfer system comprising a server arrangement communicably coupled via one or more communication networks with a first client device of the first party and a second client device of the second party.

At a step 302, information pertaining to the one or more digital assets, a transferal condition, identification details of the second party are received from the first client device of the first party.

At a step 304, the one or more digital assets are encrypted using a first key and a second key. The server arrangement stores the first key and the second key is transmitted to the second client device of the second party.

At a step 306, an access identifier for accessing the encrypted one or more digital assets is obtained. The encrypted one or more digital assets are stored in a distributed file system.

At a step 308, a smart contract is added to a blockchain. The smart contract comprises the transferal condition, a validation indicator and the access identifier. Moreover, activation of the validation indicator in the smart contract indicates a satisfaction of the transferal condition.

At a step 310, a ledger clock for the smart contract is activated. The ledger clock is configured to defer an execution of the smart contract to a next cycle of the ledger clock in response to absence of a validation indicator in the smart contract.

At a step 312, the second party is enabled to retrieve the digital asset, in response to an execution of the smart contract at a completion of a ledger clock cycle, using the second key and the access identifier of the encrypted one or more digital assets. The execution of the smart contract is based on activation of the validation indicator

The steps 302 to 312 are only illustrative and other alternatives can also be provided where one or more steps are added, one or more steps are removed, or one or more steps are provided in a different sequence without departing from the scope of the claims herein.

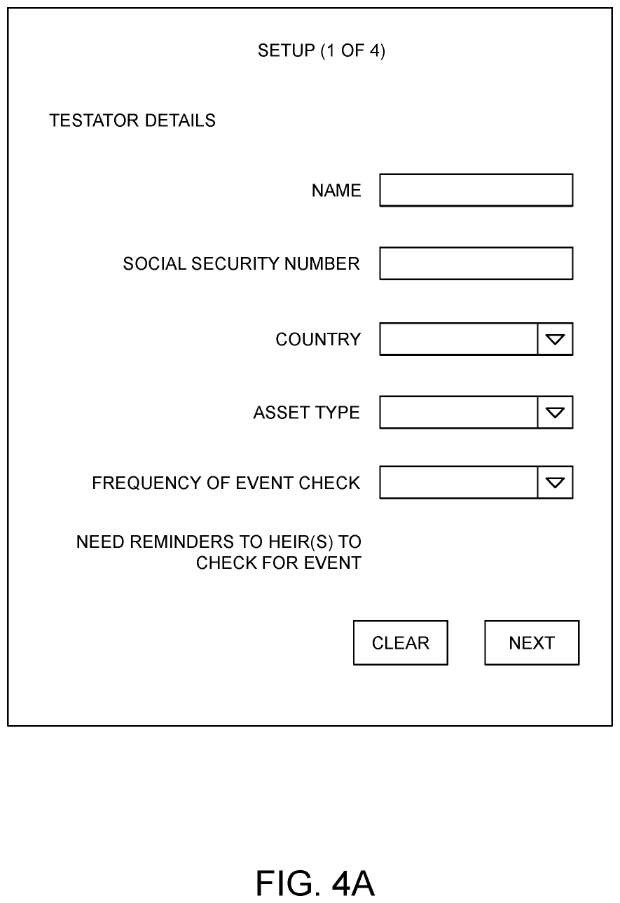

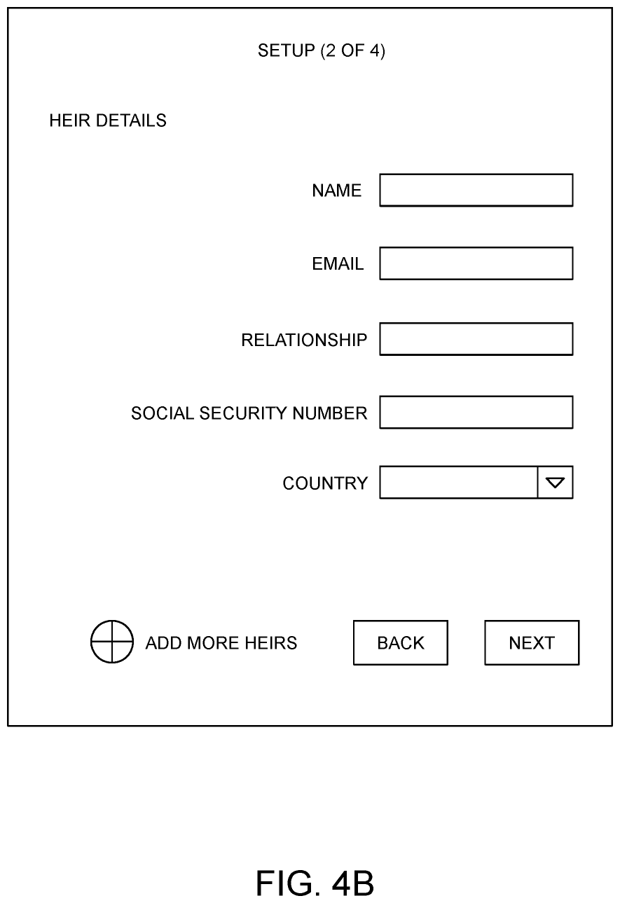

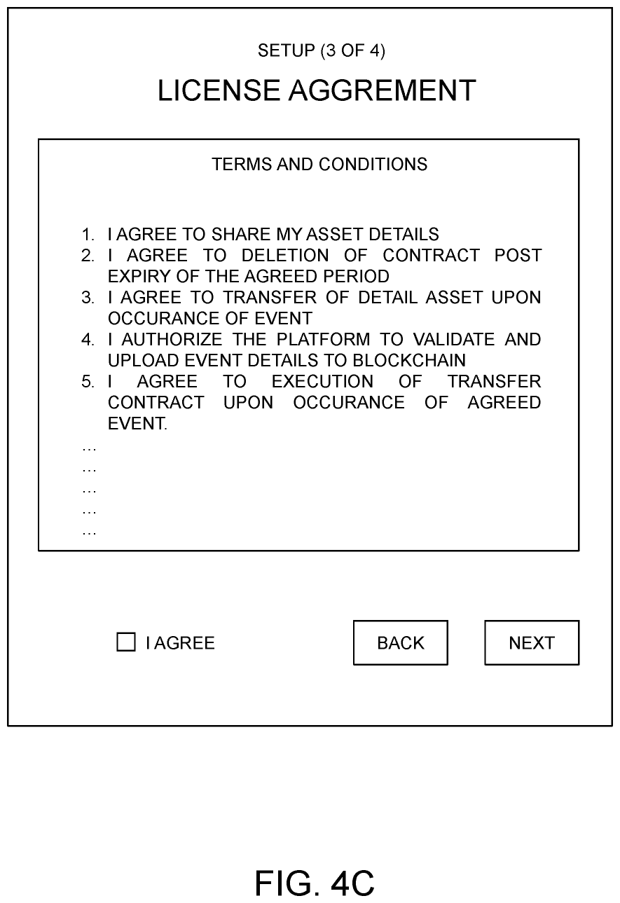

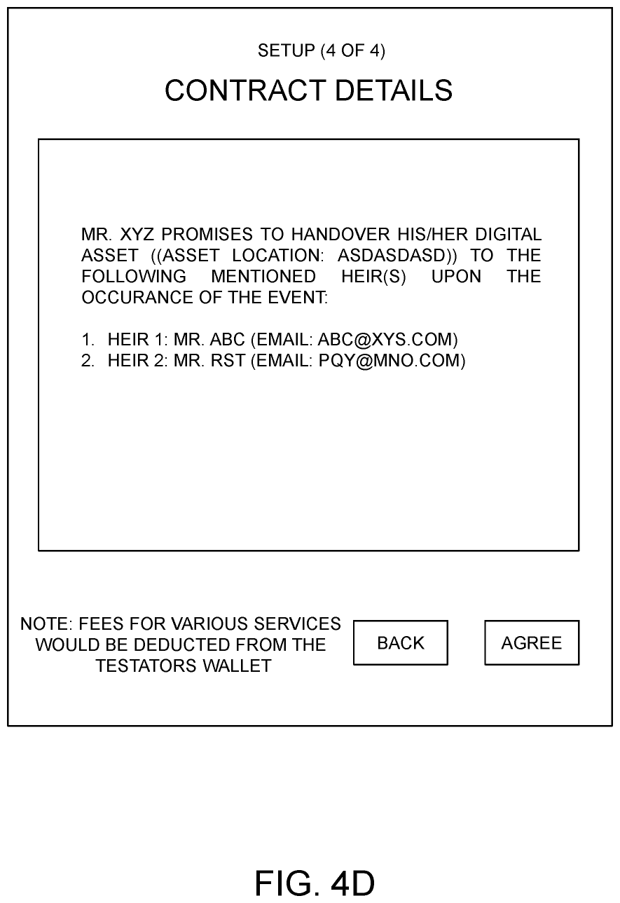

FIGS. 4A, 4B, 4C and 4D are example views of a user interface of an encrypted asset transfer system presented on a graphical user interface of a first client device or a first server of a first party, in accordance with an embodiment of the present disclosure.

With reference to FIG. 4A, a first example view includes text boxes and/or drop-down menus that allow the first party to enter details and/or select a suitable option pertaining to an identification of the first party.

With reference to FIG. 4B, a second example view includes text boxes and/or drop-down menus that allow the first party to enter details and/or select a suitable option pertaining to an identification details of the second party.

With reference to FIG. 4C, a third example view depicts an exemplary license agreement. Furthermore, the example view includes a user selectable menu that allows the first party to provide a permission to the server arrangement to facilitate the transfer of the one or more digital assets from the first party to the second party.

With reference to FIG. 4D, a fourth example view depicts an exemplary smart contract generated by the server arrangement. Notably, the smart contract includes a contract for the undertaking of the digital asset, an identification associated with the first party, and an identification associated with the second party to facilitate the transfer of one or more digital assets from first party to the second party.

FIGS. 4A, 4B, 4C and 4D are merely examples, which should not unduly limit the scope of the claims herein. A person skilled in the art will recognize many variations, alternatives, and modifications of embodiments of the present disclosure. For example, another example view of the graphical user interface can show and allow the first party to edit the plurality of information provided by the first party.

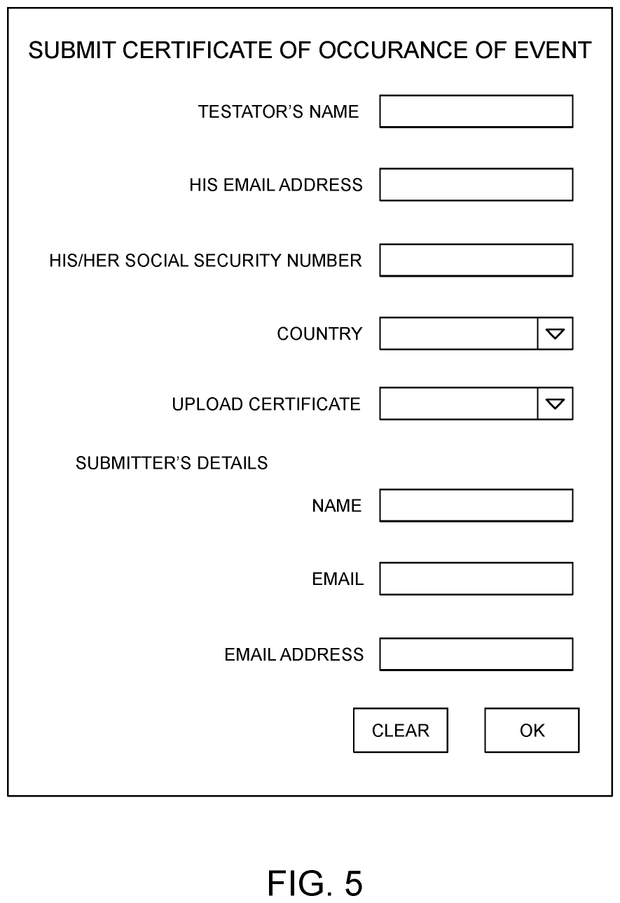

FIG. 5 is an example view of a user interface of an encrypted asset transfer system to provide credentials related to a transferal condition, in accordance with an embodiment of the present disclosure. Furthermore, the user interface of the encrypted asset transfer system to provide credentials related to a transferal condition includes text boxes and/or drop-down menus that allow the first party or the second party to enter details and/or select a suitable option. Moreover, the user interface of the encrypted asset transfer system to provide credentials related to a transferal condition is presented on a graphical user interface of a first client device of a first party and/or a second client device of a second party.

FIG. 5 is merely example, which should not unduly limit the scope of the claims herein. A person skilled in the art will recognize many variations, alternatives, and modifications of embodiments of the present disclosure. For example, another example view of the graphical user interface can allow the second party to initiate a request for accessing the form to provide credentials related to a transferal condition.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. An encrypted asset transfer system, when in operation, facilitates a transfer of one or more digital assets from a first party to a second party, the encrypted asset transfer system comprising a server arrangement communicably coupled via one or more communication networks with a first client device of the first party and with a second client device of the second party, wherein the server arrangement:
receives, from the first client device of the first party, information pertaining to the one or more digital assets, a transferal condition, identification details of the second party;
encrypts the one or more digital assets using a first key and a second key, wherein the server arrangement stores the first key and the second key is transmitted to the second client device of the second party;
obtains an access identifier for accessing the encrypted one or more digital assets, wherein the encrypted one or more digital assets are stored in a distributed file system;
adds a smart contract to a blockchain, wherein the smart contract comprises the transferal condition, a validation indicator, and the access identifier, and wherein activation of the validation indicator in the smart contract indicates a satisfaction of the transferal condition;
activates a ledger clock for the smart contract, wherein the ledger clock is configured to defer an execution of the smart contract to a next cycle of the ledger clock in response to absence of activation of the validation indicator in the smart contract;
enables the second party to retrieve the one or more digital assets, in response to an execution of the smart contract at a completion of a ledger clock cycle, using the second key and the access identifier of the encrypted one or more digital assets, wherein the execution of the smart contract is based on activation of the validation indicator.

2. The encrypted asset transfer system of claim 1, wherein the transferal condition is satisfied upon receiving credential relating to the transferal condition.

3. The encrypted asset transfer system of claim 1, wherein the server arrangement further provides the first key and the access identifier for accessing the encrypted information pertaining to the digital assets, upon execution of the smart contract, to the second client device of the second party.

4. The encrypted asset transfer system of claim 2, wherein the server arrangement further provides an intimation message to the second party upon not receiving the credentials for satisfaction of the transferal condition prior to completion of a cycle of the ledger clock.

5. The encrypted asset transfer system of claim 2, wherein the server arrangement authenticates the credentials related to the transferal condition.

6. The encrypted asset transfer system of claim 1, wherein the information pertaining to the digital assets comprises at least one of: a type of the digital assets, a valuation associated with the digital assets.

7. The encrypted asset transfer system of claim 1, wherein the identification details of the second party comprise at least one of: a name, a country, an e-mail address, a social security number, and a relation of the second party with the first party.

8. The encrypted asset transfer system of claim 1, wherein the smart contract comprises at least one of: a distinctive identification associated with the first party, a distinctive identification associated with the second party, and a proof of witness.

9. A method for facilitating a transfer of one or more digital assets from a first party to a second party, wherein the method is implemented via an encrypted asset transfer system comprising a server arrangement communicably coupled via one or more communication networks with a first client device of the first party and with a second client device of the second party, the method comprising:
receiving, from the first client device of the first party, information pertaining to the one or more digital assets, a transferal condition, identification details of the second party;
encrypting the one or more digital assets using a first key and a second key, wherein the server arrangement stores the first key and the second key is transmitted to the second client device of the second party;
obtaining an access identifier for accessing the encrypted one or more digital assets, wherein the encrypted one or more digital assets is stored in a distributed file system;
adding a smart contract to a blockchain, wherein the smart contract comprises the transferal condition, a validation indicator and the access identifier, and wherein activation of the validation indicator in the smart contract indicates a satisfaction of the transferal condition;
activating a ledger clock for the smart contract, the ledger clock configured to defer an execution of the smart contract to a next cycle of the ledger clock in response to absence of activation of the validation indicator in the smart contract;
enabling the second party to retrieve the digital asset, in response to an execution of the smart contract at a completion of a ledger clock cycle, using the second key and the access identifier of the encrypted one or more digital assets, wherein the execution of the smart contract is based on activation of the validation indicator.

10. The method of claim 9, wherein the transferal condition is satisfied upon receiving credential relating to the transferal condition.

11. The method of claim 9, wherein the method comprises providing the first key and the access identifier for accessing the encrypted information pertaining to the digital assets, upon execution of the smart contract, to the second client device of the second party.

12. The method of claim 10, wherein the method comprises providing an intimation message to the second party upon not receiving the credentials for satisfaction of the transferal condition prior to completion of a cycle of the ledger clock.

13. The method of claim 10, wherein the method comprises authenticating the credentials related to the transferal condition.
